(19) United States
(12) Patent Application Publication
(10) Pub. No.: US 2013/0040191 A1
(43) Pub. Date: Feb. 14, 2013

(54) RECHARGEABLE BATTERY

(71) Applicant: Duk-Jung KIM, Yongin-si (KR)

(72) Inventor: Duk-Jung KIM, Yongin-si (KR)

(21) Appl. No.: 13/482,035

(22) Filed: May 29, 2012

(30) Foreign Application Priority Data
Aug. 8, 2011 (KR) 10-2011-0078813

(51) Int. Cl. H01M 2/30

(52) U.S. Cl. 429/179

(57) ABSTRACT

A rechargeable battery includes: a first electrode assembly and a second electrode assembly for performing charging and discharging; a case having an inner cavity, the inner cavity retaining the first electrode assembly and the second electrode assembly; a lead tab including a first tab connected to the first electrode assembly and the second electrode assembly, and a pair of second tabs, the pair of second tabs being respectively connected to the first electrode assembly and the second electrode assembly; and a terminal electrically connected to the first and second electrode assemblies through the lead tab, the terminal protruding outside the case.

### BACKGROUND

1. Field

Embodiments relate to a rechargeable battery.

2. Description of the Related Art

A rechargeable battery can be recharged and discharged, unlike a primary battery that cannot be recharged. A rechargeable battery with low capacity may be used for a small portable electronic device such as a mobile phone, a laptop computer, and a camcorder. A rechargeable battery with large capacity may be used as a power source for driving a motor for devices requiring a large amount of power, e.g., a hybrid vehicle.

Recently, a large capacity high-output rechargeable battery using a non-aqueous electrolyte solution with high energy density has been developed. The large capacity high-output rechargeable battery includes a large-capacity battery module in which a plurality of rechargeable batteries are connected to each other in series so as to be used to drive a motor for devices requiring a large amount of power, such as an electric car.

Also, a large capacity high power rechargeable battery generally includes a plurality of rechargeable batteries that are coupled with each other in series, and each of the rechargeable batteries may be formed in a cylindrical shape, a prismatic shape, or a pouch shape.

The above information disclosed in this Background section is only for enhancement of understanding of the background of the described technology and therefore it may contain information that does not form the prior art that is already known in this country to a person of ordinary skill in the art.

### SUMMARY

One or more embodiments may provide a rechargeable battery including a first electrode assembly and a second electrode assembly for performing charging and discharging; a case having an inner cavity, the inner cavity retaining the first electrode assembly and the second electrode assembly; a lead tab including: a first tab connected to the first electrode assembly and the second electrode assembly, and a pair of second tabs, the pair of second tabs being respectively connected to the first electrode assembly and the second electrode assembly; and a terminal electrically connected to the first and second electrode assemblies through the lead tab, the terminal protruding outside the case.

The rechargeable battery may further include an electrode fixer between the first and second electrode assemblies and between the case and the first and second electrode assemblies, the electrode fixer securing the electrode assemblies inside the case. The electrode fixer may include a base on a bottom surface of the inner cavity; and a protrusion protruding from the base between the first electrode assembly and the second electrode assembly, the protrusion maintaining a position of the electrode assembly. The first tab may include an inserting groove at an end thereof, and an end of the protrusion may be in the inserting groove of the first tab. The protrusion may include a first protrusion protruding from the base, the first protrusion having a first cross-sectional area; and a second protrusion extending from an end of the first protrusion, a part of an end of the second protrusion extending into the inserting groove, the second protrusion having a second cross-sectional area, and the second cross-sectional area being less than the first cross-sectional area.

The first electrode assembly and the second electrode assembly being connected to each other by an uncoated region, the uncoated region having no active material thereon. Uncoated regions may protrude from the first electrode assembly and the second electrode assembly toward the first tab, the first electrode assembly and the second electrode assembly being connected through the first tab. The lead tab may include one or more hollow portions.

The rechargeable battery may further include a cap plate from which the terminal protrudes, the cap plate being on the case and integrally formed with the second tab.

One or more embodiments may provide a rechargeable battery including a first electrode assembly and a second electrode assembly for performing charging and discharging; a case having an inner cavity, the inner cavity retaining the first electrode assembly and the second electrode assembly; a lead tab including: a first tab extending between and connected to the first electrode assembly and the second electrode assembly, a pair of second tabs, each of the second tabs connected to the first electrode assembly or the second electrode assembly; a terminal electrically connected to the first and second electrode assemblies through the lead tab, the terminal protruding outside the case; and an electrode fixer on a bottom surface of the inner cavity, the electrode fixer having a protrusion extending to the first tab between first electrode assembly and the second electrode assembly.

### BRIEF DESCRIPTION OF THE DRAWINGS

The embodiments will become apparent to those of ordinary skill in the art by describing in detail exemplary embodiments with reference to the attached drawings, in which:

FIG. 1 illustrates a perspective view of a rechargeable battery according to an exemplary embodiment.

FIG. 2 illustrates a partial cutaway view of the rechargeable battery shown in FIG. 1, without the case.

FIG. 3 illustrates an exploded perspective view of the rechargeable battery of FIG. 1.

FIG. 4 illustrates a cross-sectional view of the rechargeable battery of FIG. 1 with respect to a line A-A of FIG. 1.

### DETAILED DESCRIPTION

Korean Patent Application No. 10-2011-0078813, filed on Aug. 8, 2011, in the Korean Intellectual Property Office, and entitled: “Rechargeable Battery,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element or substrate, or intervening elements may also be present. Further, it will be understood that when an element is referred to as being “under” another element, it can be directly under, and one or more intervening elements may also be present. In addition, it will also be understood that when an element is referred to as being “between” two elements, it can be the only element between the two elements, or one or more intervening elements may also be present. Like reference numerals refer to like elements throughout.

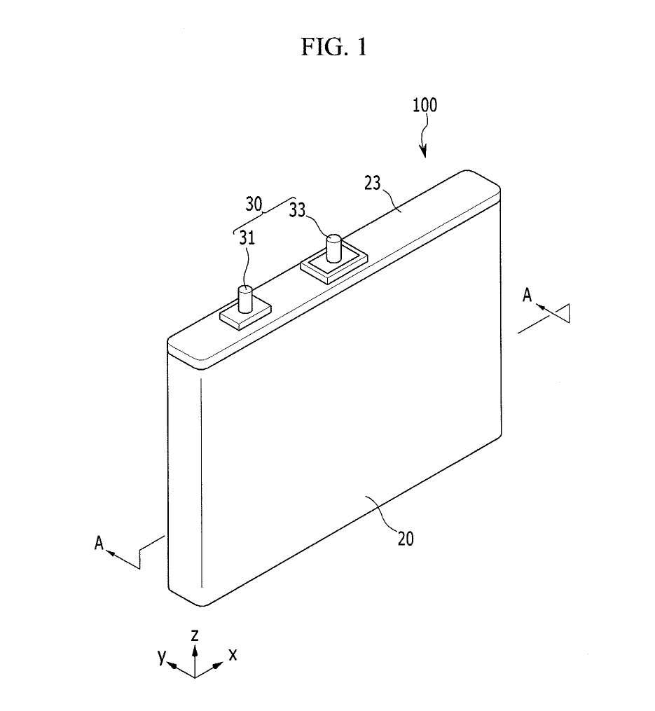

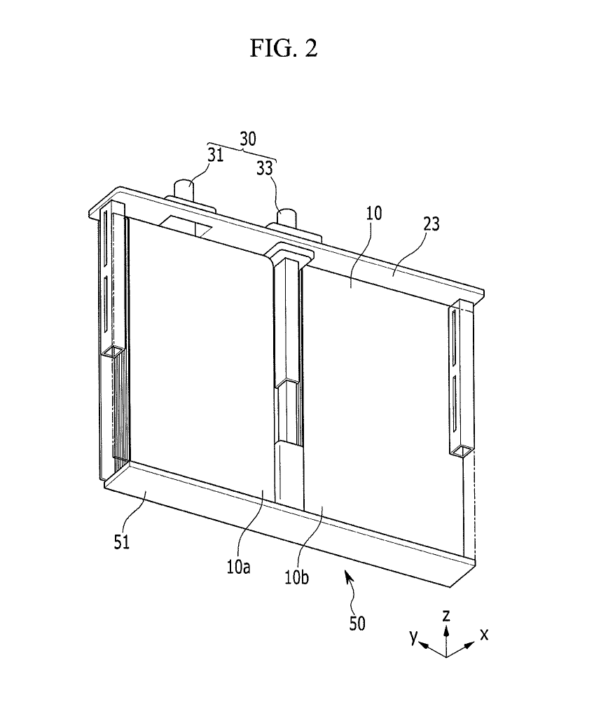

FIG. 1 illustrates a perspective view of a rechargeable battery according to an exemplary embodiment. FIG. 2 illustrates a partial cutaway view of the rechargeable battery shown in FIG. 1, without the case.

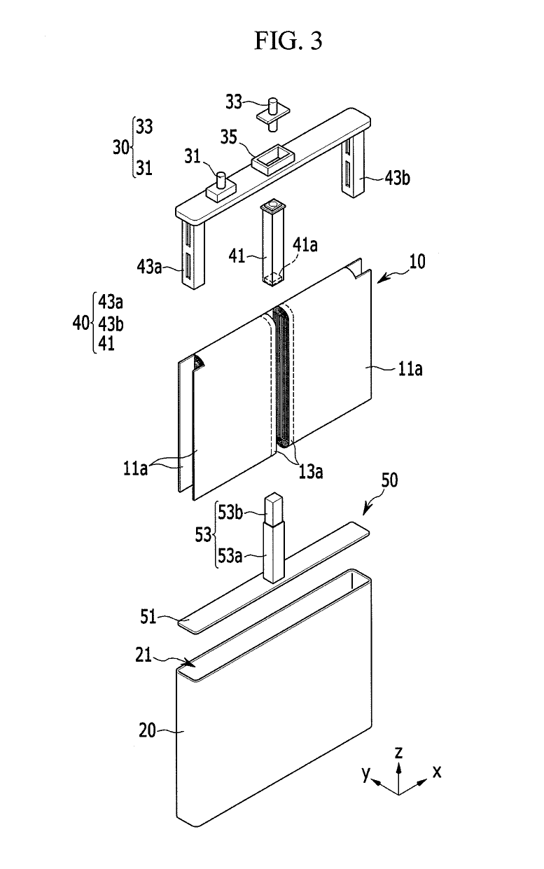

As shown in FIG. 1 and FIG. 2, the rechargeable battery 100 may include a first electrode assembly 10a and a second electrode assembly 10b (for performing a charge and discharge operation), a case 20 (in which the first electrode assembly 10a and the second electrode assembly 10b are installed), a lead tab 40 (see FIG. 3) including a first tab 41 and second tabs 43a and 43b. The first tab 41 may be coupled with the first electrode assembly 10a, the second electrode assembly 10b, and a terminal 30. The terminal 30, (electrically connected to the electrode assemblies 10a and 10b through the lead tab 40), may protrude outside the case 20. An electrode fixer 50 (for fixing positions of, e.g., securing, the electrode assemblies 10a and 10b in the case 20) may be inserted between the electrode assemblies 10a and 10b and the case 20. Also, a cap plate 23 may be installed in an opening 21 (see FIG. 3) of the case 20. The terminal 30 (which may include a positive terminal 31 and a negative terminal 33) may be installed in, e.g., may extend through, the cap plate 23.

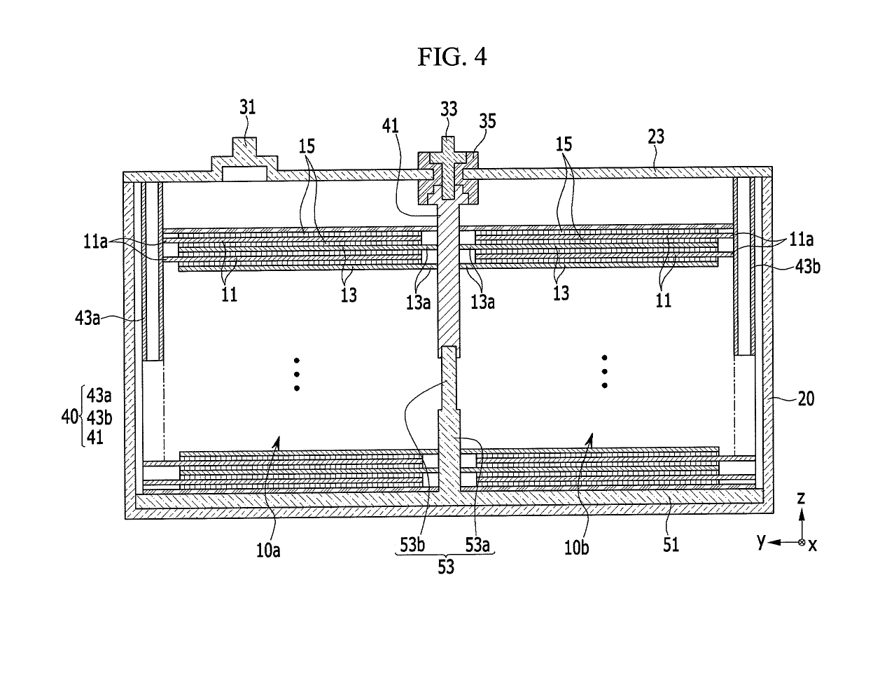

FIG. 3 illustrates an exploded perspective view of the rechargeable battery of FIG. 1. FIG. 4 illustrates a cross-sectional view with respect to a line A-A of FIG. 1.

As shown in FIG. 3 and FIG. 4, a positive electrode 11 and a negative electrode 13 may each include a coated region (formed by coating an active material on a current collector including a thin-plate metal foil) and uncoated regions 11a and 13a (representing regions of the positive electrode 11 and the negative electrode 13 which are not coated with active material). The positive uncoated region 11a may be formed on one side of the positive electrode 11 and may extend in a length direction, i.e., y-direction, of the positive electrode 11, and the negative uncoated region 13a may be formed on one side of the negative electrode 13 and may extend in the length direction, i.e., y-direction of the negative electrode 13.

The positive electrode 11 and the negative electrode 13 may be stacked, e.g., disposed one on top of another, and a separator 15, e.g., an insulator, may be disposed therebetween. The positive electrode 11 and the negative electrode 13 may be spirally wound to form electrode assemblies 10a and 10b in a jelly roll shape.

The electrode assemblies 10a and 10b may be pressed to be flat, to facilitate installation in the case 20. The positive uncoated region 11a may protrude from one side of each of the electrode assemblies 10a and 10b, and the negative uncoated region 13a may protrude from another side, e.g., opposing side, of the electrode assemblies 10a and 10b. The positive uncoated region 11a of each of the electrode assemblies 10a and 10b may be connected to a corresponding one of the second tabs 43a and 43b of the lead tab 40, described below, and the negative uncoated region 13a may be connected to the first tab 41 of the lead tab 40, described below. Further description of the configuration of the positive uncoated region 11a, the negative uncoated region 13a, and the lead tab 40 is provided below, along with the description of the lead tab 40.

The electrode assemblies 10a and 10b may be installed in pairs inside the case 20. The first electrode assembly 10a and the second electrode assembly 10b may be connected together, e.g., at their negative uncoated regions 13a. According to an embodiment, the electrode assemblies 10a and 10b may be independently installed inside the case 20, and may not be connected by their negative uncoated regions 13a.

The case 20 may include a conductive metal, such as aluminum, an aluminum alloy, or nickel-plated steel. The case 20 may be formed in a prismatic shape, such as a hexahedron, in which the opening 21 may be formed on one side and through which the electrode assemblies 10a and 10b may be installed in an inner cavity within the case 20. The cap plate 23 may be installed in the opening 21 of the case 20. The terminal 30, including the positive terminal 31 and the negative terminal 33, may protrude through or from the cap plate 23. The positive terminal 31 may be integrally formed with the cap plate 23, and the negative terminal 33 may be detachably coupled with the cap plate 23. According to an embodiment, the negative terminal 33 may be insulated from the cap plate 23 by a gasket 35.

The lead tab 40 may electrically connect the terminal 30 and the electrode assemblies 10a and 10b. The lead tab 40 may include the first tab 41 and the second tabs 43a and 43b. The first tab 41 may be commonly accessed by or coupled with the electrode assemblies 10a and 10b. For example, the first tab 41 may include a single member, e.g., pillar-like member, to which both electrode assemblies 10a and 10b may be connected. The second tabs 43a and 43b may be individually accessed by or coupled with the electrode assemblies 10a and 10b. For example, the electrode assembly 10a may be connected to the second tab 43a and the electrode assembly 10b may be connected to the second tab 43b. The configuration of the first tab 41 and the second tabs 43a and 43b will now be described in further detail.

The first tab 41 may be provided between the first electrode assembly 10a and the second electrode assembly 10b, and may be connected to the negative electrode 13 (of the first electrode assembly 10a and the second electrode assembly 10b) and the negative terminal 33. The single first tab 41 may advantageously reduce the number of components needed to connect the first electrode assembly 10a, the second electrode assembly 10b, and the negative terminal 33. For example, the single first tab 41 may be commonly, e.g., simultaneously, coupled with the negative electrode 13 of the first electrode assembly 10a and the second electrode assembly 10b, and the negative terminal 33.

The second tabs 43a and 43b may be connected with the electrode assemblies 10a and 10b, respectively, to connect the positive electrode 11 of the electrode assemblies 10a and 10b with the positive terminal 31. The second tabs 43a and 43b may be connected to a positive uncoated region 11a of the electrode assemblies 10a and 10b, respectively. The positive uncoated region 11a may protrude from a side of each of the electrode assemblies 10a and 10b. For example, as shown in FIG. 3, a pair of positive uncoated regions 11a may protrude from the side of the electrode assemblies 10a and 10b. The second tabs 43a and 43b may be inserted between the positive uncoated regions 11a. Accordingly, each of the positive uncoated regions 11a may be connected to opposing sides of a corresponding one of the second tabs 43a and 43b. As such, the connection between the second tabs 43a and 43b and the positive uncoated regions 11a may be further reinforced. The second tabs 43a and 43b and the positive terminal 31 may be connected with the conductive cap plate 23. The positive terminal 31 may be formed by configuring a part of the cap plate 23 to have a terminal, e.g., cylindrical, shape. For example, the positive terminal 31 and the cap plate 23 may be integrally formed. In an implementation, however, the positive terminal 31 may be detachably connected to the cap plate 23. The second tabs 43a and 43b may be hollow. As such, the amount of materials needed for manufacturing the first tab 43, and associated manufacturing costs, may be reduced.

In addition, the electrode fixer 50 (for stably retaining the electrode assemblies 10a and 10b in the case 20) may be installed inside the case 20. For example, the electrode fixer 50 may be in the inner cavity of the case 20. The electrode fixer 50 may include a base 51 that is supported by a bottom surface of the inner cavity. A protrusion 53 may protrude from the base 51, e.g., extend in the z-direction from the base 51. The protrusion 53 may be between the first electrode assembly 10a and the second electrode assembly 10b and may control or fix a position of the electrode assemblies 10a and 10b. For example, the protrusion 53 may prevent or minimize movement of the electrode assemblies 10a and 10b.

The base 51 may have a plate shape. The base 51 may be installed between the bottom surface of the inner cavity of the case 20 and the electrode assemblies 10a and 10b. The base 51 may have a length that corresponds to the length of the case 20, and may not move inside the case 20. For example, the base 51 may fit securely within the case 20. The protrusion 53 may protrude from the base 51 towards the opening 21 of the case 20.

The protrusion 53 may protrude from the center of the base 51 towards the opening 21 of the case 20, in the length direction, e.g., z-direction. The protrusion 53 may include a first protrusion 53a, with a relatively large cross-sectional area, protruding from the base 51, and a second protrusion 53b, with a smaller cross-sectional area than that of the first protrusion 53a, extending from an end of the first protrusion 53a.

The first protrusion 53a may have a width that corresponds to a separation distance between the first electrode assembly 10a and the second electrode assembly 10b. For example, the first electrode assembly 10a and the second electrode assembly 10b may be separated by the first protrusion 53a. The first protrusion 53a may help prevent movement of the electrode assemblies 10a and 10b inside the case 20 when an external impact is sustained. Accordingly, in the event of an external impact to the rechargeable battery 100, a malfunction, such as a short circuit, may be prevented.

The second protrusion 53b, having a lesser cross-sectional area than that of the first protrusion 53a, may protrude from a free end of the first protrusion 53a (e.g., opposite to the base 51) so that a part of a protruded end, e.g., free end, of the second protrusion 53b may be inserted into the first tab 41. An inserting groove 41 a (for receiving the end of the second protrusion 53b) may be formed in the first tab 41. The second protrusion 53b may be inserted into the first tab 41 so the electrode fixer 50 may be stably positioned inside the case 20. Similarly, insertion of the second protrusion 53b into the first tab 41 may further stabilize or secure the first tab 41 within the case 20.

In addition, the positive terminal 31 and the negative terminal 33 may protrude from the top of the cap plate 23. In an implementation, the negative terminal 33 may be substantially at a center of the cap plate 23, and the positive terminal 31 may be between the negative terminal 33 and an edge of the cap plate 23. Hence, when a bus bar (not shown) is assembled, it is possible to prevent misassembly that may result from the positions of the negative terminal 33 and the positive terminal 31, e.g, insufficient distance between the negative terminal 33 and the positive terminal 31.

By way of summation and review, the prismatic-shaped rechargeable battery includes an electrode assembly that has an anode and a cathode with a separator interposed therebetween, a case having a space incorporating the electrode assembly, and a cap plate that seals the case and has a terminal hole in which a electrode terminal is inserted, and the electrode terminal is electrically connected with the electrode assembly, inserted in the terminal hole, and protruded outside the case. A plurality of electrode assemblies can be installed inside a single case so as to increase capacity of the rechargeable battery. However, when a plurality of electrode assemblies are installed in the case, an external impact may cause each electrode assembly to move inside the case and cause a short circuit, thereby deteriorating stability. Further, a large quantity of additional components may be required for installing a plurality of electrode assemblies inside the case.

One or more embodiments may provide a rechargeable battery for improving stability and reducing the number of components used to install a plurality of electrode assemblies in a case.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery, comprising:
a first electrode assembly and a second electrode assembly for performing charging and discharging;
a case having an inner cavity, the inner cavity retaining the first electrode assembly and the second electrode assembly;
a lead tab including:
a first tab connected to the first electrode assembly and the second electrode assembly, and
a second tab, the second tab being respectively connected to the first electrode assembly and the second electrode assembly; and
a terminal electrically connected to the first and second electrode assemblies through the lead tab, the terminal protruding outside the case.

2. The rechargeable battery as claimed in claim 1, further comprising an electrode fixer between the first and second electrode assemblies and between the case and the first and second electrode assemblies, the electrode fixer securing the electrode assemblies inside the case.

3. The rechargeable battery as claimed in claim 2, wherein the electrode fixer includes:
a base on a bottom surface of the inner cavity; and
a protrusion protruding from the base between the first electrode assembly and the second electrode assembly, the protrusion maintaining a position of the electrode assembly.

4. The rechargeable battery as claimed in claim 3, wherein the first tab includes an inserting groove at an end thereof, and an end of the protrusion is in the inserting groove of the first tab.

5. The rechargeable battery as claimed in claim 4, wherein the protrusion includes:
a first protrusion protruded to the base; and
a second protrusion extended at the end of the first protrusion, a part of the end being inserted into the first tab, and being formed to have a cross-section that is less than that of the first protrusion.

6. The rechargeable battery as claimed in claim 1, wherein the first electrode assembly and the second electrode assembly are connected to each other at an uncoated region, the uncoated region having no active material thereon.

7. The rechargeable battery as claimed in claim 1, wherein uncoated regions protrude from the first electrode assembly and the second electrode assembly toward the first tab, the first electrode assembly and the second electrode assembly being connected through the first tab.

8. The rechargeable battery as claimed in claim 1, wherein the lead tab includes one or more hollow portions.

9. The rechargeable battery as claimed in claim 1, further comprising a cap plate from which the terminal protrudes, the cap plate being on the case and integrally formed with the second tab.
